(19) United States
(12) Patent Application Publication
(10) Pub. No.: US 2012/0173636 A1
(43) Pub. Date: Jul. 5, 2012

(54) CREATING IMPLICIT INSTANT MESSAGING CONTACT LIST GROUPS

(75) Inventors: Patrick Joseph O'Sullivan, Ballsbridge (IE); Sean Callanan, Churchtown (IE); Ruthie D. Lyle, Durham, NC (US); Fred Raguillat, Dunboyne (IE); Carol Sue Zimmet, Boxborough, MA (US)

(73) Assignee: International Business Machines Corporation, Armonk, NY (US)

(21) Appl. No.: 12/982,538

(22) Filed: Dec. 30, 2010

(51) Int. Cl. G06F 15/16

(52) U.S. Cl. 709/206

(57) ABSTRACT

One or more interactions of a user are monitored. The one or more interactions are analyzed to determine a plurality of intersecting interaction users. An implicit instant messaging contact list group is created for the user. The implicit instant messaging contact list group includes at least a portion of the plurality of intersecting interaction users.

### BACKGROUND OF THE DISCLOSURES

The present disclosure relates to instant messaging, and more particularly relates to automatically generating contact list groups.

Instant messaging creates the possibility of real-time text-based communication between two or more participants over a network, such as the Internet or an intranet. As such, instant messaging has a much greater perceived synchronicity of communication, as compared to technologies such as email. For example, instant messaging may allow effective and efficient communication, featuring immediate receipt of acknowledgement or reply. In addition to pure text-based communication, instant messaging may allow users to see each other using web cameras, experience direct voice communication, and the like.

Many instant messaging systems allow users to create and maintain an explicit contact list, which may be a deterministic group including instant messaging screen names of other users. Often a user will populate their contact list with those individuals with whom the user most frequently exchanges instant messages. Populating explicit contacts lists may be accomplished, for example, by manually inputting the screen name of a user to be added to a contact list.

### SUMMARY OF THE DISCLOSURE

According to a first implementation, a method includes monitoring, by a computing device, one or more interactions of a user. The one or more interactions are analyzed, by the computing device, to determine a plurality of intersecting interaction users. The method also includes creating, by the computing device, an implicit instant messaging contact list group for the user. The implicit instant messaging contact list group includes at least a portion of the plurality of intersecting interaction users.

One or more of the following features may be included. The one or more interactions may include one or more of an email exchange, a web conference, a telephone interaction, presence in a team room, and contribution to a website. Monitoring the one or more interactions may include querying one or more of one or more interaction systems and one or more interaction repositories.

Analyzing the one or more interactions may include evaluating the one or more interactions over a time-wise basis. Creating an implicit instant messaging contact list group may include creating the implicit instant messaging contact list group based upon, at least in part, one or more user settings regarding one or more of a frequency of interaction and a duration of interaction.

The implicit instant messaging contact list group may be maintained based upon, at least in part, a recency of the one or more interactions. The user may be allowed to create an explicit instant messaging contact item based upon, at least in part a contact item from the implicit instant messaging contact list group.

According to another implementation, a computer program product resides on a computer readable medium having a plurality of instructions stored on it. When executed by a processor, the instructions cause the processor to perform operations including monitoring one or more interactions of a user. The instructions also cause the processor to analyze the one or more interactions to determine a plurality of intersecting interaction users. Instructions also cause the processor to create an implicit instant messaging contact list group for the user. The implicit instant messaging contact list group including at least a portion of the plurality of intersecting interaction users.

One or more of the following features may be included. The one or more interactions may include one or more of an email exchange, a web conference, a telephone interaction, presence in a team room, and contribution to a website. The instructions for monitoring the one or more interactions may include instructions for querying one or more of one or more interaction systems and one or more interaction repositories.

The instructions for analyzing the one or more interactions may include instructions for evaluating the one or more interactions over a time-wise basis. The instructions for creating an implicit instant messaging contact list group may include instructions for creating the implicit instant messaging contact list group based upon, at least in part, one or more user settings regarding one or more of a frequency of interaction and a duration of interaction.

Instructions may be included for maintaining the implicit instant messaging contact list group based upon, at least in part, a recency of the one or more interactions. Instructions may be included for allowing the user to create an explicit instant messaging contact item based upon, at least in part a contact item from the implicit instant messaging contact list group.

According to another implementation, a system includes a processor and a memory. A first software module is executable by the processor and the memory. The first software module is configured to monitor one or more interactions of a user. A second software module is executable by the processor and the memory. The second software module is configured to analyze the one or more interactions to determine a plurality of intersecting interaction users. A third software module is also executable by the processor and the memory. The third software module is configured to create an implicit instant messaging contact list group for the user, the implicit instant messaging contact list group including at least a portion of the plurality of intersecting interaction users.

One or more of the following features may be included. The one or more interactions may include one or more of an email exchange, a web conference, a telephone interaction, presence in a team room, and contribution to a website. The first software module, configured to monitor the one or more interactions, may be further configured to query one or more of one or more interaction systems and one or more interaction repositories.

The second software module, configured to analyze the one or more interactions, may be further configured to evaluate the one or more interactions over a time-wise basis. The third software module, configured to create an implicit instant messaging contact list group, may be further configured to create the implicit instant messaging contact list group based upon, at least in part, one or more user settings regarding one or more of a frequency of interaction and a duration of interaction.

A fourth software module may be executable by the processor and the memory. The fourth software module may be configured to maintain the implicit instant messaging contact list group based upon, at least in part, a recency of the one or more interactions. A fifth software module may be executable by the processor and the memory. The fifth software module may be configured to allow the user to create an explicit instant messaging contact item based upon, at least in part a contact item from the implicit instant messaging contact list group.

The details of one or more implementations are set forth in the accompanying drawings and the description below. Other features will become apparent from the description, the drawings, and the claims.

BRIEF DESCRIPTION OF THE SEVERAL VIEWS OF THE DRAWINGS

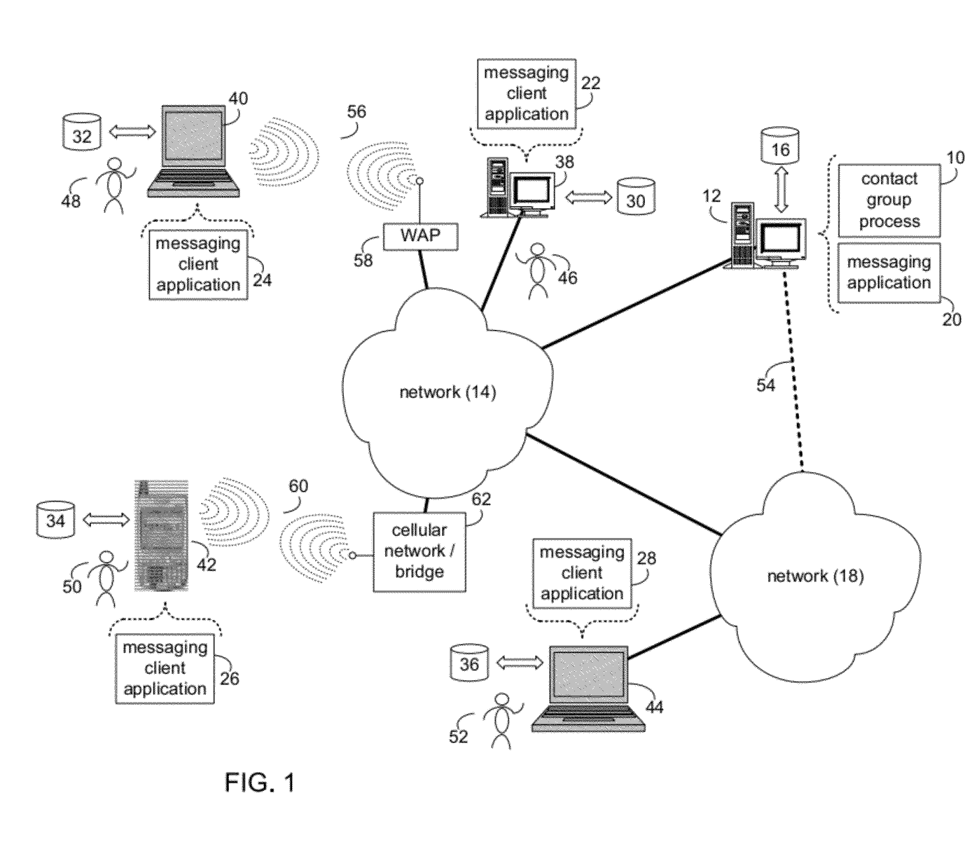

FIG. 1 diagrammatically depicts a contact group process coupled to a distributed computing network.

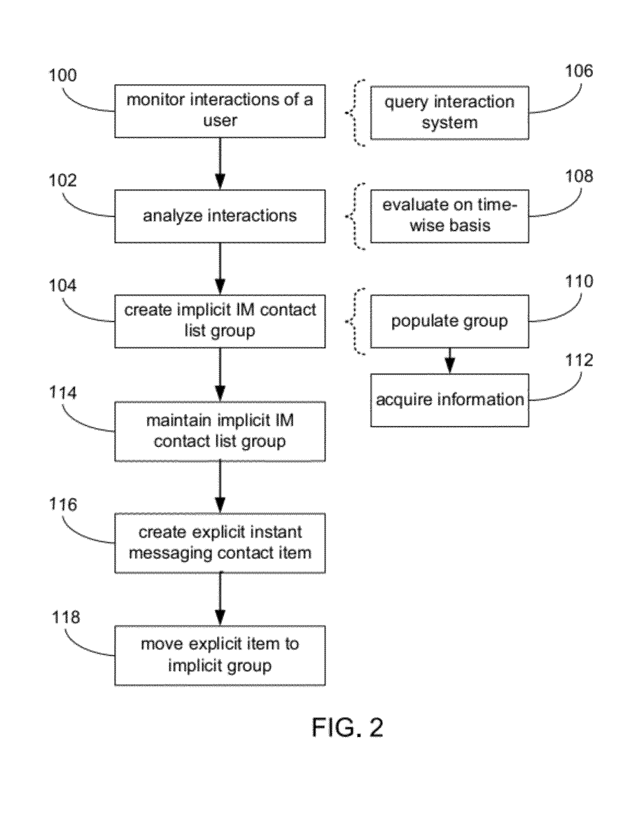

FIG. 2 is a flowchart of a process executed by the contact group process of FIG. 1.

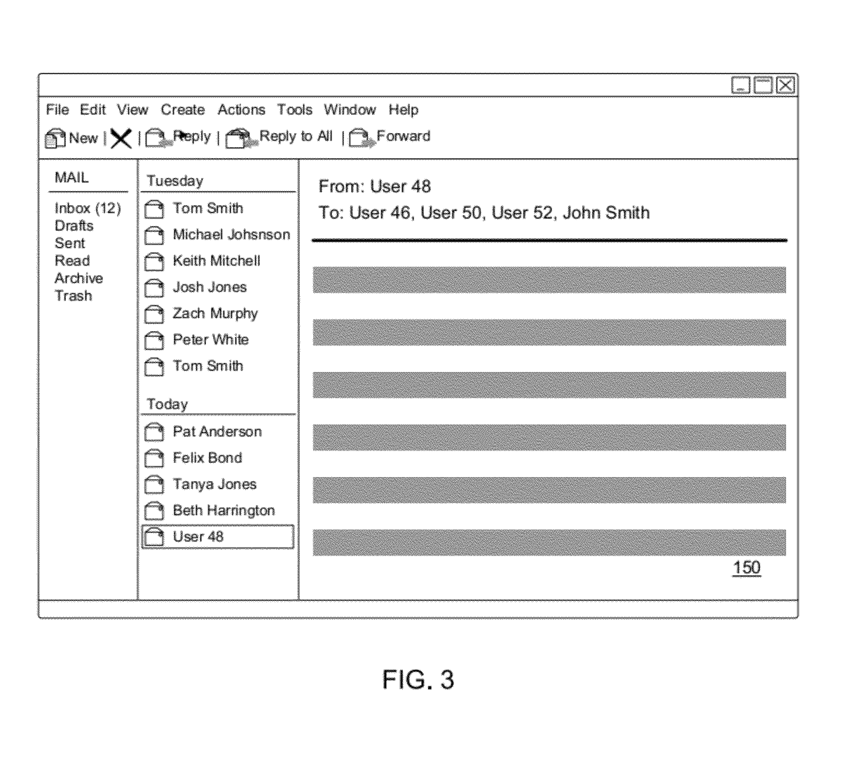

FIG. 3 graphically depicts an email interaction that may be monitored and analyzed by the contact group process of FIG. 1.

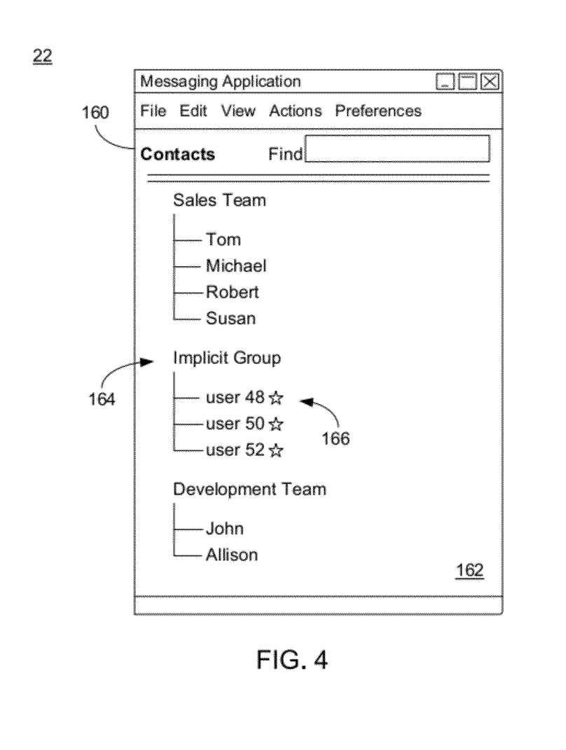

FIG. 4 graphically depicts an instant messaging user interface that may be provided by a messaging client application of FIG. 1.

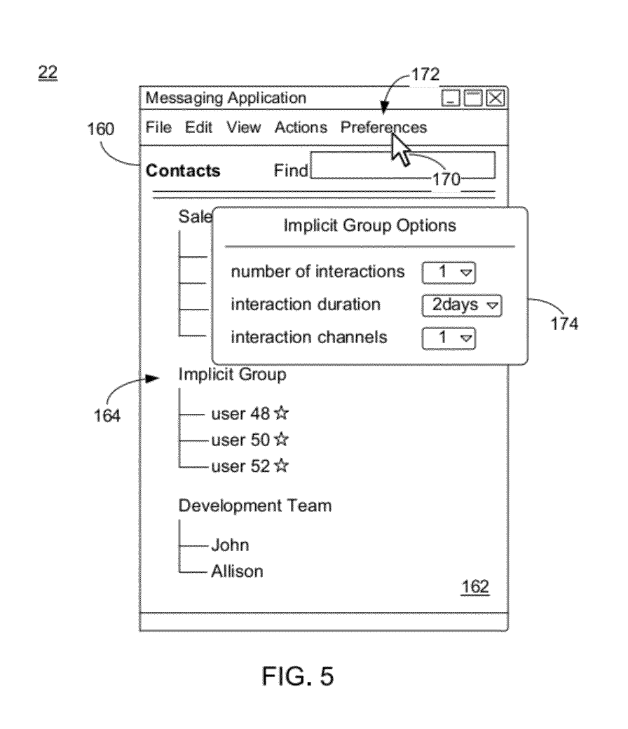

FIG. 5 graphically depicts an instant messaging user interface and contact group preferences that may be provided by a messaging client application and/or the contact group process of FIG. 1.

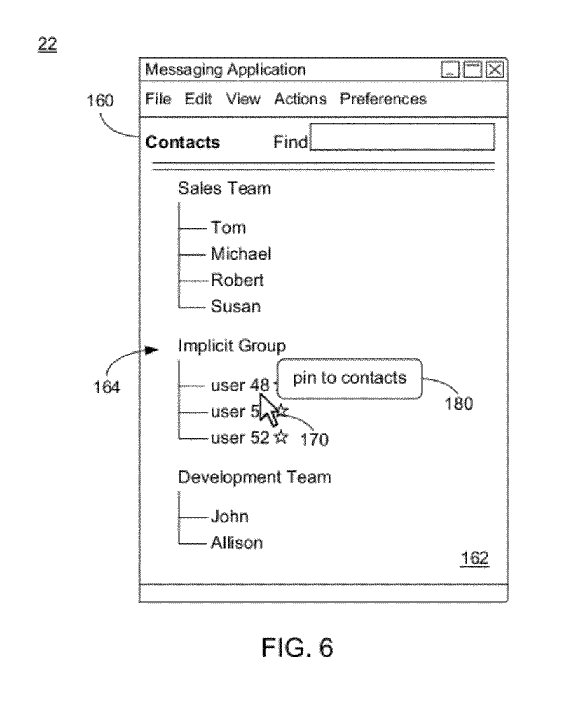

FIG. 6 graphically depicts an instant messaging user interface that may be provided by a messaging client application and/or the contact group process of FIG. 1.

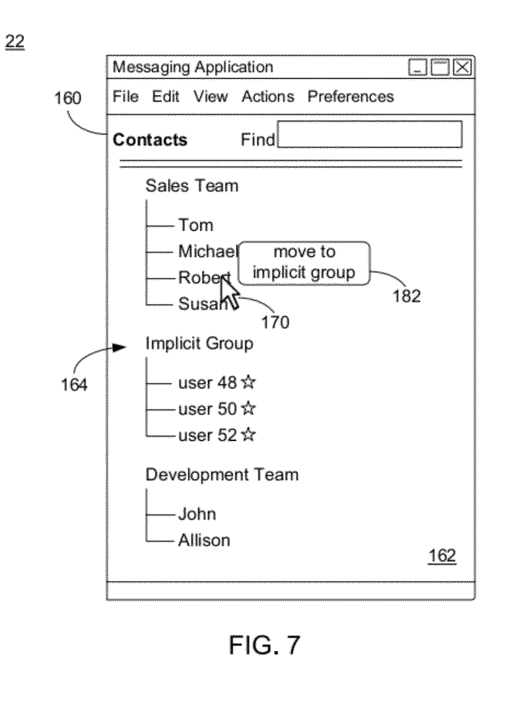

FIG. 7 graphically depicts an instant messaging user interface that may be provided by a messaging client application and/or the contact group process of FIG. 1.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer readable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Referring to FIG. 1, there is shown contact group process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® Server; Novell® NetWare®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.) Additionally/alternatively, the contact group process may reside on and be executed, in whole or in part, by a client electronic device, such as a personal computer, notebook computer, personal digital assistant, or the like.

As will be discussed below in greater detail, contact group process 10 may monitor one or more interactions of a user. Contact group process 10 may also analyze the one or more interactions to determine a plurality of intersecting interaction users. Contact group process 10 may further create an implicit instant messaging contact list group for the user. The implicit instant messaging contact list group includes at least a portion of the plurality of intersecting interaction users.

The instruction sets and subroutines of contact group process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM).

Server computer 12 may execute a web server application, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Server computer 12 may execute an instant messaging application (e.g., messaging application 20), examples of which may include, but are not limited to, IBM Lotus® Sametime®, Microsoft Live Communications Server™, and AOL Instant Messenger® (Lotus and Sametime are registered trademarks of IBM Corporation in the United States, other countries, or both; Live Communications Server is a trademark of Microsoft Corporation in the United States, other countries, or both; AOL Instant messenger is a registered trade mark of AOL Inc. in the United States, other countries, or both). for example. Messaging application 20 may allow instant messaging communications to be exchanged via instant messaging client applications, e.g., messaging client applications 22, 24, 26, 28, examples of which may include, but are not limited to, IBM Lotus® Sametime®, Microsoft Office Communicator™, Google Talk, and AOL Instant Messenger® (Communicator is a trademark of Microsoft Corporation in the United States, other countries, or both; Google Talk is a trademark of Google Inc in the United States, other countries, or both), for example. Contact group process 10 may be a stand alone application, or may be an applet/application/script that may interact with and/or be executed within messaging application 20. In addition/as an alternative to being a server-side process, the contact group process may be a client-side process (not shown) that may reside on a client electronic device (described below) and may interact with a messaging client application (e.g., one or more of messaging client applications 22, 24, 26, 28). Further, the contact group process may be a hybrid server-side/client-side process that may interact with messaging application 20 and a messaging client application (e.g., one or more of messaging client applications 22, 24, 26, 28). As such, the contact group process may reside, in whole, or in part, on server computer 12 and/or one or more client electronic devices.

The instruction sets and subroutines of messaging application 20, which may be stored on storage device 16 coupled to server computer 12 may be executed by one or more processors (not shown) and one or more memory modules (not shown) incorporated into server computer 12.

The instruction sets and subroutines of messaging client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44 (respectively). Storage devices 30, 32, 34, 36 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, mobile computing device 42 (such as a smart phone, netbook, or the like), notebook computer 44, for example. Using client applications 22, 24, 26, 28, users 46, 48, 50, 52 may access messaging application 20 and may allow users to e.g., send and receive instant messaging communications.

Users 46, 48, 50, 52 may access messaging application 20 directly through the device on which the messaging client application (e.g., messaging client applications 22, 24, 26, 28) is executed, namely client electronic devices 38, 40, 42, 44, for example. Users 46, 48, 50, 52 may access messaging application 20 directly through network 14 or through secondary network 18. Further, server computer 12 (i.e., the computer that executes messaging application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Mobile computing device 42 is shown wirelessly coupled to network 14 via wireless communication channel 60 established between mobile computing device 42 and cellular network/bridge 62, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows, Microsoft Windows CE®, Red Hat Linux, or other suitable operating system. (Windows CE is a registered trademark of Microsoft Corporation in the United States, other countries, or both.)

For the purpose of the following description, messaging client application 22 may be discussed. However, this is for illustrative purposes only and should not be construed as a limitation of the present disclosure, as other client applications (e.g., client application 24, 26, 28) may be equally utilized.

Referring also to FIG. 2, contact group process 10 may monitor 100 one or more interactions of a user. Contact group process 10 may also analyze 102 the one or more interactions to determine a plurality of intersecting interaction users. Contact group process 10 may further create 104 an implicit instant messaging contact list group for the user. The implicit instant messaging contact list group includes at least a portion of the plurality of intersecting interaction users. As such, contact group process 10 may create an instant messaging contact list group including individuals with whom the user has a relationship that may be inferred by the one or more interactions. Implicit instant messaging contact list groups may include groups of contacts that may be automatically added to an instant messaging contact list based upon, at least in part, an inferred or implied relationship between the user and the contacts, as opposed to explicit contact groups, which may be a deterministic group that the user may create by directly adding contacts, e.g., by manually inputting the contacts.

As mentioned above, contact group process 10 may allow an instant messaging contact list group to be created including individuals with whom a user (e.g., user 46) has a relationship that is implied or inferred based upon one or more interactions that user 46 may have with the group of individuals. The group may reside in a list of contacts maintained by and instant messaging system. The list of contacts may be accessible via an instant messaging application (e.g., messaging application 22). The contacts list may include, for example, instant messaging screen names, and may be used, for example, in conducting instant messaging exchanges with other users. The group created by contact group process 10 may provide a context for a grouping of individuals. For example, the grouping may arise out of the one or more interactions of the user, and may include individuals intersecting via the one or more interactions.

The one or more interactions may include one or more of an email exchange, a web conference, a telephone interaction, presence in a team room, and contribution to a website. For example, user 46 may be one recipient of an email exchange that may include a plurality of recipients. The email exchange may include several emails (e.g., an original email, and one or more subsequent replies) during with the plurality of recipients may carry out a discussion surrounding a particular topic. Similarly, the interaction may include one or more web conferences that may include a plurality of common participants. In a similar manner, user 46 may engage in teleconferences, calendaring/scheduling events (e.g., which may be reflected by one or more items maintained in by a calendaring/scheduling system or application). User 46 may also be present in a team room, or collaborative online workspace, along with several other users, or may contribute to a website (such as a wiki), that may also have several other users. Various additional/alternative interactions may also be monitored by contact group process 10.

Monitoring 100 the one or more interactions may include querying 106 one or more of one or more interaction systems and one or more interaction repositories. For example, contact group process 10 may query 106 an email system, such as an email server application or an email client application associated with the user (e.g., user 46) for email that include a plurality of recipients. Similarly, contact group process 10 may query 106 a telephone system (e.g., such as PBX management system) for information regarding conference calls, e.g., which may include a plurality of individuals on a common call. Calendaring/scheduling systems (either calendaring/scheduling server applications and/or calendaring/scheduling client applications associated with the user), collaborative online interaction systems and the like may similarly be queried 106 by contact group process 10. Additionally/alternatively, interactions and/or interaction patterns for a user may be stored in an interaction repository (e.g., a database that may reside, for example, on storage device 16 associated with server computer 12). As discussed above, such interactions may include, e.g., email information, information regarding conference calls, calendaring/scheduling events, etc. Contact group process 10 may query 106 the interaction repository for interaction information associated with the user.

For example, and referring also to FIG. 3, contact group process 10 may query 106 an email system (e.g., an email server application and/or an email client application associated with user 46) for email threads including a plurality of recipients. In response to the query 106, email 150 may be identified. As shown, email 150 may include a plurality of recipients (e.g., user 46, user 48, user 50, and user 52). Additionally, email 150 may include, for example, 20 responses spanning four days. Contact group process 10 may analyze 102 the one or more interactions (e.g., email 150) of the user (e.g., user 46). Analyzing 102 the one or more interactions of the user may allow contact group process 10 to determine a pattern of interactions between the user (e.g., user 46) and a plurality of intersecting interactions users (e.g., user 48, user 50, user 52 having email 150 as a common point of intersection). In the case of email 150, the determined pattern of interaction between user 46 and users 48, 50, 52 may include email 150, representing 20 exchanges over a four day period. The number of exchanges (e.g., 20 exchanges) and the time period (e.g., a four day period) may be indicative of an ongoing relationship between user 46 and user 48, 50, and 52 (e.g., which may be for a common purpose and/or surrounding a common topic or basis).

Analyzing 102 the one or more interactions may include evaluating 108 the one or more interactions over a time-wise basis. For example, an interaction occurring a single time, in a single day may have a relatively lower likelihood of desirably being leveraged as an instant messaging contact list group, e.g., to facilitate ongoing, or future, collaboration. However, an email thread, such as email 150 including 20 exchanges over a four-day period, may imply an, at least temporary, ongoing collaboration. Such collaboration may have a relatively higher likelihood of desirably being leveraged as an instant messaging contact list group, e.g., to facilitate ongoing, or future collaboration. Additionally, evaluating 108 the one or more interactions over a time-wise basis may indicate that the same users may commonly interact over various interaction channels. For example, in addition to email 150, users 46, 48, 50, and 52 may have also been common participants in web conference in a time period surrounding the email exchange.

Based upon, at least in part, the monitored 100 and analyzed 102 one or more interactions of the user, contact group process 10 may create 104 an implicit instant messaging contact list group including at least a portion of the plurality of intersecting interaction users. The instant messaging contact list group may be an implicit group in that the group may be derived from a relationship between the group members (e.g., the at least a portion of the intersecting interaction users) that may be implied by the one or more interactions. As mentioned above, the individuals common to the one or more interactions may be intersecting interaction users in that they have the one or more interactions as a common point of intersection. Contact group process 10 may populate 110 the created 104 implicit instant messaging contact list group with at least a portion of the intersecting interactions users (e.g., users 48, 50, and 52). For example, and referring also to FIG. 4, instant messaging user interface 160 (e.g., provided by messaging client application 22 alone, and/or in conjunction with one or more of messaging application 20 and contact group process 10) may include contact list 162 including various instant messaging contacts and contact groups for user 46. Contact group process 10 may create implicit instant messaging contact list group 164 in contact list 162 associated with user 46. Implicit instant messaging contact list group 164 may include intersecting interaction users 48, 50, and 52, for example. Further, in some embodiments, implicit instant messaging contacts (e.g., users 48, 50, 52 in the foregoing example) may be graphically indicated as an implicitly added contact, e.g., via icon 166, or other suitable means. Icon 166 may allow a user (e.g., user 46) to quickly differentiate between implicitly added contacts and explicitly added contacts.

Populating 110 the implicit instant messaging contact list group may include populating 110 the implicit instant messaging contact list group with less than all of the intersecting interaction users. For example, assume that email 150 additionally included “John Smith” as a recipient. However, also assume that John Smith did not participate n any of the 20 exchanges. As such, in some embodiments, John Smith may not be included in the implicit instant messaging contact list group. Various additional/alternative criteria may be utilized for populating 110 the implicit instant messaging contact list group.

Contact group process 10 may acquire 112 information (e.g., instant messaging screen name, as well as various additional/alternative contact information) for populating 110 the implicit instant messaging contact list group from, for example, a corporate directory, or other such directory that may be used to correlate information obtained via the one or more interactions (e.g., an email user name) with an instant messaging screen name. Various additional/alternative sources may equally be utilized for deriving an instant messaging screen name for the plurality of intersecting interaction users.

The implicit instant messaging contact list group based upon, at least in part, one or more user settings regarding one or more of a frequency of interaction and a duration of interaction. As discussed above, it may be less likely that a limited interaction between a plurality of users would desirably be leveraged to provide an instant messaging contact list group to facilitate further interaction. Similarly, it may also be less likely that infrequent interactions may desirably be leveraged to provide an instant messaging contact list group to facilitate further interaction. In some embodiments, contact group process 10 may allow a user to define preferences for creating 104 an implicit instant messaging contact list group.

For example, and referring also to FIG. 5, from within instant messaging user interface 160, user 46 may select, e.g., via onscreen pointer 170 (which may be controlled by a pointing device, such as a mouse; not shown) preferences menu 172. Selecting preferences menu 172 may result in messaging client application 22 (alone or in conjunction with contact group process 10) rendering preferences popup 174. As shown, preferences popup may include a variety of options allowing user 46 to determine threshold attributes for creating 104 an implicit instant messaging contact list group. While preferences popup 174 is shown including various preferences that may be set (namely, number of interactions, duration of interactions, frequency of interaction, and number of interaction channels) this is intended for illustrative purposes only, as the number and nature of preferences that may be included may vary depending upon user preference and design criteria.

Contact group process 10 may maintain 114 the implicit instant messaging contact list group based upon, at least in part, a recency of the one or more interactions. As discussed above, a relationship between the user and the plurality of intersecting interaction users may be inferred based upon, at least in part, one or more interactions of the user. Contact group process 10 may dynamically create 104 an implicit instant messaging contact list group based upon, at least in part, the inferred or implied relationship. Just as such a relationship may arise, the relationship may similarly go stale, with the number, nature, and/or frequency of interactions decreasing or stopping. Contact group process 10 may maintain 114 the implicit instant messaging contact list group by keeping the implicit instant messaging contact list group active while one or more interactions including the plurality of intersecting interaction users persists, and by discontinuing and/or removing the implicit instant messaging contact list group when one or more interactions including the plurality of intersecting interaction users declines or ceases. According to various embodiments, contact group process 10 may grey-out the implicit instant messaging contact list group before ultimately deleting the implicit instant messaging contact list group. Further, contact group process 10 may require user affirmation (e.g., in the form of accepting a delete option in a popup dialog box) prior to deleting the implicit instant messaging contact list group. Contact group process 10 may allow a user to define user preferences for the deletion of the implicit instant messaging contact list group (e.g., such as the time since last interaction, threshold frequency of interaction for maintaining the implicit instant messaging contact list group, or the like). The number and nature of user preferences may vary depending upon design criteria and user need.

Contact group process 10 may allow the user to create 116 an explicit instant messaging contact item based upon, at least in part a contact item from the implicit instant messaging contact list group. For example, and referring to FIG. 6, user 46 may select (e.g., via onscreen pointer 170) an individual user (e.g., user 48 in the illustrated example) from implicit instant messaging contact list group 164 (or the entire implicit instant messaging contact list group), for example by right-clicking on user 48. Selecting user 48 from within implicit instant messaging contact list group 164 may result in messaging client application 22 (alone or in conjunction with contact group process 10) rendering popup 180. Popup 180 may include the option “pin to contacts.” Selecting the option “pin to contacts” (e.g., using onscreen pointer 170) may result in creating and explicit instant messaging contact item for user 48 (i.e., an instant messaging contact list created by user 46). Creating 116 the explicit instant messaging contact item for user 48 may include creating a copy of user 48 in explicit instant messaging contact list 162, and leaving a copy of user 48 within implicit instant messaging contact list group 164. Additionally/alternatively, creating 116 an explicit instant messaging contact list item for user 48 may remove user 48 from implicit instant messaging contact list group 164. Creating 116 an explicit instant messaging contact item based upon, at least in part a contact item from the implicit instant messaging contact list group may, for example, prevent the at least one contact item from being deleted in the even the implicit instant messaging contact list group becomes stale and is deleted by contact group process 10.

In a related manner, contact group process 10 may allow the user to move 118 at least one explicit instant messaging contact list item to the implicit instant messaging contact list group. For example, and referring to FIG. 7, user 46 may select (e.g., via onscreen pointer 170) an individual user (e.g., “Robert” in the illustrated example) from the explicit instant messaging contact list, e.g., by right-clicking on “Robert.” Selecting “Robert” from the explicit instant messaging contact list may result in messaging client application 22 (alone or in conjunction with contact group process 10) rendering popup 182. Popup 182 may include the option to “move to implicit group.” Moving 118 “Robert” to the implicit instant messaging contact list group 164 may include creating a copy of “Robert” in implicit instant messaging contact list group 164 and leaving a copy of “Robert” within the explicit instant messaging contact list. Additionally/alternatively, moving 118 “Robert” to the implicit instant messaging contact list group 164 may remove “Robert” from the explicit instant messaging contact list.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A computer implemented method comprising:
monitoring, by a computing device, one or more interactions of a user;
analyzing, by the computing device, the one or more interactions to determine a plurality of intersecting interaction users; and
creating, by the computing device, an implicit instant messaging contact list group for the user, the implicit instant messaging contact list group including at least a portion of the plurality of intersecting interaction users.

2. The computer implemented method according to claim 1, wherein the one or more interactions include one or more of an email exchange, a web conference, a telephone interaction, presence in a team room, and contribution to a website.

3. The computer implemented method according to claim 1, wherein monitoring the one or more interactions includes querying one or more of one or more interaction systems and one or more interaction repositories.

4. The computer implemented method according to claim 1, wherein analyzing the one or more interactions includes evaluating the one or more interactions over a time-wise basis.

5. The computer implemented method according to claim 1, wherein creating an implicit instant messaging contact list group includes creating the implicit instant messaging contact list group based upon, at least in part, one or more user settings regarding one or more of a frequency of interaction and a duration of interaction.

6. The computer implemented method according to claim 1, further comprising maintaining the implicit instant messaging contact list group based upon, at least in part, a recency of the one or more interactions.

7. The computer implemented method according to claim 1, further comprising allowing the user to create an explicit instant messaging contact item based upon, at least in part a contact item from the implicit instant messaging contact list group.

8. A computer program product residing on a computer readable storage medium having a plurality of instructions stored thereon, which, when executed by a processor, cause the processor to perform operations comprising:
monitoring one or more interactions of a user;
analyzing the one or more interactions to determine a plurality of intersecting interaction users; and
creating an implicit instant messaging contact list group for the user, the implicit instant messaging contact list group including at least a portion of the plurality of intersecting interaction users.

9. The computer program product according to claim 8, wherein the one or more interactions include one or more of an email exchange, a web conference, a telephone interaction, presence in a team room, and contribution to a website.

10. The computer program product according to claim 8, wherein the instructions for monitoring the one or more interactions include instructions for querying one or more of one or more interaction systems and one or more interaction repositories.

11. The computer program product according to claim 8, wherein the instructions for analyzing the one or more interactions include instructions for evaluating the one or more interactions over a time-wise basis.

12. The computer program product according to claim 8, wherein the instructions for creating an implicit instant messaging contact list group include instructions for creating the implicit instant messaging contact list group based upon, at least in part, one or more user settings regarding one or more of a frequency of interaction and a duration of interaction.

13. The computer program product according to claim 8, further comprising instructions for maintaining the implicit instant messaging contact list group based upon, at least in part, a recency of the one or more interactions.

14. The computer program product according to claim 8, further comprising instructions for allowing the user to create an explicit instant messaging contact item based upon, at least in part a contact item from the implicit instant messaging contact list group.

15. A system comprising:
a processor;
a memory;
a first software module executable by the processor and the memory, the first software module configured to monitor one or more interactions of a user;
a second software module executable by the processor and the memory, the second software module configured to analyze the one or more interactions to determine a plurality of intersecting interaction users; and
a third software module executable by the processor and the memory, the third software module configured to create an implicit instant messaging contact list group for the user, the implicit instant messaging contact list group including at least a portion of the plurality of intersecting interaction users.

16. The system according to claim 15, wherein the one or more interactions include one or more of an email exchange, a web conference, a telephone interaction, presence in a team room, and contribution to a website.

17. The system according to claim 15, wherein the first software module, configured to monitor the one or more interactions, is further configured to query one or more of one or more interaction systems and one or more interaction repositories.

18. The system according to claim 15, wherein the second software module, configured to analyze the one or more interactions, is further configured to evaluate the one or more interactions over a time-wise basis.

19. The system according to claim 15, wherein the third software module, configured to create an implicit instant messaging contact list group, is further configured to create the implicit instant messaging contact list group based upon, at least in part, one or more user settings regarding one or more of a frequency of interaction and a duration of interaction.

20. The system according to claim 15, further comprising a fourth software module executable by the processor and the memory, the fourth software module configured to maintain the implicit instant messaging contact list group based upon, at least in part, a recency of the one or more interactions.

21. The system according to claim 15, further comprising a fifth software module executable by the processor and the memory, the fifth software module configured to allow the user to create an explicit instant messaging contact item based upon, at least in part a contact item from the implicit instant messaging contact list group.
